(19) United States
(12) Patent Application Publication
(10) Pub. No.: US 2014/0260375 A1
(43) Pub. Date: Sep. 18, 2014

(54) MODULAR COOLING SYSTEM FOR BEVERAGE DISPENSER AND RELATED METHODS

(71) Applicant: Illinois Tool Works Inc., Glenview, IL (US)

(72) Inventors: Brian Casserilla, Haslet, TX (US); Joseph F. Sanders, North Richland Hills, TX (US)

(73) Assignee: Illinois Tool Works Inc., Glenview, IL (US)

(21) Appl. No.: 14/187,719

(22) Filed: Feb. 24, 2014

Related U.S. Application Data
(60) Provisional application No. 61/793,612, filed on Mar. 15, 2013.

(51) Int. Cl. B67D 3/00

(52) U.S. Cl. CPC B67D 3/0009
USPC 62/98; 62/389; 62/344

(57) ABSTRACT

A cold beverage dispensing system includes a beverage dispenser having an ice maker and at least one nozzle for dispensing a beverage formed by multiple components including water. A method of operating the system involves: mounting at least one condensing unit on a frame; interconnecting the condensing unit with a heat exchanger such that coolant exiting the at least one condensing unit follows a flow path through the heat exchanger and back to the at least one condensing unit; connecting a water supply of the beverage dispenser to feed into the heat exchanger for being cooled; and connecting a cooled water outlet of the heat exchanger to a water supply input of the beverage dispenser such that cooled water from the cooled water outlet is used by the beverage dispenser as a component of the beverage dispensed by the nozzle.

### CROSS-REFERENCE TO RELATED APPLICATIONS

This application claims priority to U.S. Provisional Application Ser. No. 61/793,612, filed on 13 Mar. 2013, and entitled “Modular Cooling System For Beverage Dispenser And Related Methods,” the entire disclosure of which is incorporated by reference.

### FIELD

This application relates generally to beverage dispensers and, more specifically, to an apparatus and method for dispensing cool beverages that utilizes a modular cooling system.

### BACKGROUND

Beverage dispensers are used throughout the world in public facilities such as cafeterias, bars, restaurants, arenas, and stadiums to dispense carbonated beverages, water, and other beverages to consumers, and typically include either mechanical refrigeration systems or bulk refrigerants, such as ice, to cool the beverages before dispensing.

In the case of bulk refrigeration, an ice bin is typically provided with a cold plate at the bottom of the ice bin. Ice sits atop the cold plate, which may be constructed of an aluminum casting having stainless steel tubing imbedded therein in serpentine shaped fluid passages within which the beverages and/or beverage components (syrups and water) are passed before they are dispensed. The ice on top of the cold plate thus cools the beverages and/or beverage components traveling through the serpentine passages via the heat conducted through the aluminum cold plate. Multiple beverage components, such as carbonated water and syrup, are mixed at the dispensing valve. With this arrangement, the consumer is provided with a chilled beverage and a source for ice to include in the beverage. It is also known in such systems to provide a secondary cooling source in relation to the cold plate, thereby reducing the cooling load on the ice itself. Specifically, the cold plate can be cooled by a coolant source that is also passed through serpentine tubing within the plate.

However, the above system is not readily adaptable for use with soda dispensers that are already placed in the field. Moreover, any loading on the ice is generally disadvantageous, particularly during peak demand times.

### SUMMARY

In one aspect, a method is provided for operating a cold beverage dispensing system that includes a beverage dispenser having an ice maker and at least one nozzle for dispensing a beverage formed by multiple components including water. The method involves: mounting at least one condensing unit on a frame; interconnecting the condensing unit with a heat exchanger such that coolant exiting the at least one condensing unit follows a flow path through the heat exchanger and back to the at least one condensing unit; connecting a water supply of the beverage dispenser to feed into the heat exchanger for being cooled; and connecting a cooled water outlet of the heat exchanger to a water supply input of the beverage dispenser such that cooled water from the cooled water outlet is used by the beverage dispenser as a component of the beverage dispensed by the nozzle.

In another aspect, a method is provided for operating a cold beverage dispensing system that includes a beverage dispenser having an ice maker and at least one nozzle for dispensing a beverage formed by multiple components including water. The method involves: identifying a dispensing load of the beverage dispenser; based upon the identified dispensing load, selecting a number of condensing units to be used for chilling incoming water to the beverage dispenser, wherein the number corresponds to the dispensing load; mounting the condensing units on a common frame; interconnecting each of the condensing units with a heat exchanger such that (i) coolant-exiting the condensing units in parallel is combined and follows a common flow path through the heat exchanger and (ii) coolant exiting the heat exchanger is as single flow is split into parallel paths to feed the condensing units; connecting a water supply of the beverage dispenser to feed into the heat exchanger for being cooled; and connecting a cooled water outlet of the heat exchanger to a water supply input of the beverage dispenser such that cooled water from the cooled water outlet is used by the beverage dispenser as a component of the beverage dispensed by the nozzle.

In a further aspect, a system for dispensing cold beverages includes a beverage dispenser and a cooling arrangement. The beverage dispenser includes an ice maker and at least one nozzle for dispensing a beverage formed by multiple components including water. The cooling arrangement includes multiple condensing units mounted on a common frame and a heat exchanger. The condensing units are interconnected with the heat exchanger such that (i) coolant exiting the condensing units in parallel is combined and follows a common flow path through the heat exchanger and (ii) coolant exiting the heat exchanger as single flow is split into parallel paths to feed the condensing units. A water supply is connected to feed into the heat exchanger for being cooled, a cooled water outlet of the heat exchanger connected to deliver cooled water to the beverage dispenser such that the cooled water is used by the beverage dispenser as a component of the beverage dispensed by the nozzle.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic depiction of an embodiment of a beverage dispensing system;

FIG. 2 is a perspective view of an embodiment of a modular cooling arrangement for a beverage dispensing system; and

FIG. 3 is a schematic view of one modular condensing unit.

### DETAILED DESCRIPTION

Referring to FIG. 1, a modular beverage dispensing system 10 is shown and includes a beverage dispenser 12 having an ice maker 14 for making ice and feeding it into an ice bin or compartment 16. The ice may be accessible to consumers via a sliding door (not shown) or may be fed along an ice feed path 18 to an ice dispensing port 20 of the machine (e.g., as is known in the art of beverage dispensing). The beverage dispenser also includes one or more nozzles 22 for dispensing a beverages such as sodas or other flavored drinks. Such beverages are commonly formed by multiple components, including water and one or more syrup flavorings. Operation of each of the nozzles may be triggered by a respective actuator 24 such as an associated button (which may be manually depressed by hand) or a mechanical levers (which may be operated by being moved by a cup held below the nozzle by a person).

The beverage dispenser has a water supply input 26 that is connected to receive cooled water from a cooling arrangement 28. The cooling arrangement 28 includes one or more modular condensing units 30 mounted on a common frame 32, where the modular condensing units may be identical units (e.g., same size and/or capacity). The cooling arrangement also includes a heat exchanger 34 with a fresh water input 36 and cooled water output 38, and a coolant input 40 and coolant output 42. In an embodiment, the heat exchanger may be of a type including a plurality of internal stacked metal plates that are used to transfer heat from the water traveling through the heat exchanger (e.g., represented by 44) to the coolant traveling through the heat exchanger (e.g., represented by 46). However, other heat exchanger configurations could be used.

The condensing units 30 are interconnected with the heat exchanger 34 such that coolant exiting the condensing units in parallel via respective coolant outputs 48 is combined (e.g., into a common pipe or tubing flow path 50) for delivery to the coolant input 40 of the heat exchanger 34. Thus, the coolant follows a common flow path 46 through the heat exchanger. Coolant exits the coolant output 42 of the heat exchanger as single flow (e.g., along a common pipe or tubing flow path 52) and then splits into parallel paths 54 that connect to respective coolant inputs 56 to feed each of the condensing units 30. In one embodiment, a glycol coolant is used, but the use of other coolants is contemplated as well. A pump 55 drives coolant flow in the system and a glycol expansion tank 57 is provided.

As one example of other coolants, propane may be used as a coolant. Generally, coolants other than propane are used due to the need to use a relatively large amount of propane in order to cool the heat exchanger. With the modular design of the inventive subject matter described herein, however, propane can be used as a coolant. For example, each modular condensing unit 30 can use a relatively small amount of propane as a coolant. Collectively, several modular condensing units 30 combined together can achieve increased cooling with relatively small amounts of propane coolant being used by each of the modular condensing units 30.

A water supply 58 is connected to feed fresh water into the heat exchanger 34 for being cooled. The cooled water outlet 38 of the heat exchanger is connected to deliver cooled water (e.g., water at between about thirty-five degrees Fahrenheit and about fifty-five degrees Fahrenheit) to the water input 26 of the beverage dispenser 12. The cooled water may follow a path 60 through a cold plate 62 in the ice bin (such as previously described above) before reaching the nozzles. Optionally, the cold water may follow a path 64 that leads directly to the nozzles without passing through a cold plate. Typically, the ice maker 14 will receive a supply of water from a separate input, but in an embodiment, the cooled water could also be delivered to the ice maker 14 (e.g., along path 66) for making ice. Optionally, the beverage dispenser may lack an ice maker altogether, with ice from a separate source being occasionally added to the ice compartment (e.g., by the bucket load) manually as needed.

A controller 70 of the cooling arrangement 28 is connected and configured to control operation of the condensing units 30 and pump 55. In an embodiment, the condensing units 30, which are arranged in parallel as described above, are all commonly turned ON or commonly turned OFF according to whether there is demand for coolant. For example, in an embodiment, the temperature of the coolant on the return path 52 may be monitored by a temperature sensor 72 to control the units 30 (e.g., when the temperature rises above a high set temperature, the units 30 are turned ON and when the temperature is below a low set temperature the units 30 are turned OFF, where the separation between the high and low set temperatures may be several degrees or less). Alternatively, one or other conditions may be monitored such as temperature of the heat exchanger itself (e.g., as indicated by a temperature sensor 73). In another embodiment, each modular condensing unit 30 may be independently controlled (e.g., turned ON and OFF) based, for example, on the temperature of the heat exchanger 80 within each individual condensing unit 30 (e.g., as indicated by individual temperature sensors 81 that are connected with individual control units 83 of each condensing unit 30).

Optionally, the controller 70 may be a sequencing controller that is separate from the condensing units 30, but communicatively coupled with the condensing units 30 (e.g., by one or more wired and/or wireless connections) in order to control when the condensing units 30 are turned ON to cool. Such a sequencing controller 70 may separately cycle the various condensing units 30 between being ON and OFF at various temperatures. The power and/or control signals (which instruct the condensing units 30 to turn ON or turn OFF) controlled by the controller 70 may be temporally cycled so that different condensing units 30 are turned ON or OFF at a given time, and/or are cooling to different temperatures.

In one implementation, each modular condensing unit 30 includes its own pump (e.g., internal of the unit), such that the pumps are arranged in parallel with each other. Optionally, a common pump 55 may feed coolant to each of the condensing units. The condensing units 30 may, in an embodiment, be of the air cooled type.

Referring to FIG. 2, a perspective view of an embodiment of the cooling arrangement 28 is shown, where the frame 32 is an open type with a set of spaced apart bottom rails 80 having a set of rails creating an open box framework structure 82 for supporting the modular condensing units 30. However, other frame configurations could be used, including closed frame systems (e.g., formed of sheet material instead of rail material).

The above described system provides cold water to the beverage dispenser 12 such that beverages are always cool when dispensed (e.g., because the water used to mix the beverage at each nozzle is cold). Moreover, in embodiments where the water delivered to the ice maker 14 is also the cooled water, the energy consumed by the ice maker 14 to make ice will be reduced, and the ice maker 14 will be able to make a larger volume of ice per unit time.

The foregoing system represents a modular system that uses one or more condensing units 30. Where multiple units are used, they are connected in parallel for increased capacity. The number and cooling capacity of each the condensing units used can be varied according to the needs of a particular beverage dispensing system. Variable cooling capacity condensing units may also be used. Referring to FIG. 3, a single modular condensing unit 30 is shown and includes a glycol to refrigerant heat exchanger 80 (e.g., a brazed plated configuration), refrigerant compressor 90 (e.g. R-404a, R-134a or other refrigerant), air cooled condenser 92 with associated fan and motor (or other condenser type), thermal expansion valve 94 (or other refrigerant metering device), control unit 83 and power chord. The control unit may control compressor cycling ON and OFF based upon the heat exchanger temperature indicated by sensor 81 as previously noted, based upon the temperature of the returning glycol (e.g., as indicated by sensor 81′). The illustrated modular units can be installed by mounting to the frame and simple electrical power chord 96 connection and glycol supply and return line connections 98. The thermal expansion valve 94 can be used vary refrigeration capacity (e.g., according the size of the vale used).

Where more than one condensing unit 30 is used, the temperature set points of each unit 30 may be set slightly different from each other to provide modulating capacity of the system (e.g., a first unit is triggered on at a temperature of X ° F. or above, a second unit at a temperature of (X+2)° F. or above and a third unit at (X+4)° F. or above). In this manner the system operates based upon needed cooling capacity to meet the dispensing load.

Notably, different types and sizes of beverage dispensing machines will have different cooling needs for incoming water. Moreover, the same beverage machine type and size may have different cooling needs for incoming water depending upon a variety of factors, the primary one being the dispensing load on the machine. The dispensing load may be defined according to the volume of beverages and/or ice that the machine will be required to dispense over a period time, particularly over a period of peak demand placed upon the machine (e.g., during the rush of lunch hour or the prime dinner service hours). The dispensing load can also be affected by the surrounding environmental conditions. That is, one machine that dispenses a certain volume of beverage and ice over a set time in ideal environmental conditions (e.g., in an air conditioned facility having an ambient temperature 72° F.) may be considered to have a lower dispensing load than another, identical machine that dispenses that same certain volume of beverage and ice over the same set time period in less than ideal environmental conditions (e.g., in a warehouse facility having an ambient temperature of 95° F.). The temperature of the incoming water of the water supply 58 can also significantly impact the cooling capacity needed for a given installation. By providing the modular system above, in which condensing units can be placed in parallel with each other, a variety of beverage dispensing machine loads can be handled using different arrangements of common components (e.g., 1, 2 or 3 condensing units as needed, with corresponding piping/tubing as needed).

Thus, an advantageous method is provided for operating a cold beverage dispensing system that includes a beverage dispenser having an ice maker and at least one nozzle for dispensing a beverage formed by multiple components including water. The method involves: identifying a dispensing load of the beverage dispenser; based upon the identified dispensing load, selecting a number of condensing units to be used for chilling incoming water to the beverage dispenser, wherein the number corresponds to the dispensing load; mounting the condensing units on a common frame; interconnecting each of the condensing units with a heat exchanger such that (i) coolant-exiting the condensing units in parallel is combined and follows a common flow path through the heat exchanger and (ii) coolant exiting the heat exchanger is as single flow is split into parallel paths to feed the condensing units; connecting a water supply of the beverage dispenser to feed into the heat exchanger for being cooled; and connecting a cooled water outlet of the heat exchanger to a water supply input of the beverage dispenser such that cooled water from the cooled water outlet is used by the beverage dispenser as a component of the beverage dispensed by the nozzle.

As previously noted, the dispensing load may be determined as a function of one or more of volume of beverage dispensed over time, volume of ice dispensed over time and/or environmental conditions of an installation location of the beverage dispenser. The dispensing load may be an anticipated dispensing load of an installation location of the beverage dispenser (e.g., based upon statistics or data from other similar locations) or it may be an actual dispensing load as determined by data from an actual beverage dispenser that is already installed.

Typically, the condensing units will be controlled such that they are all commonly ON or commonly OFF according to one or more of (i) monitored temperature of the heat exchanger or (ii) monitored temperature of glycol coolant exiting the heat exchanger. However, in a more sophisticated arrangement the controller could selectively and individually turn on the condensing units to meet the demand at any given time (e.g., 1 of 3 units ON, 2 of 3 units ON or 3 of 3 units ON). By way of example, the temperature of the heat exchanger 80 if each condensing unit may be monitored by its own respective control 83 to evaluate when to turn that condensing unit ON and OFF. In such an arrangement, the system is truly modular in that all that is required to add each condensing unit 30 to a given installation is a power chord connection and supply and return glycol coolant hose/tube/pipe connections.

It is to be clearly understood that the above description is intended by way of illustration and example only, is not intended to be taken by way of limitation, and that other changes and modifications are possible.

1. A method of operating a cold beverage dispensing system that includes a beverage dispenser having an ice maker and at least one nozzle for dispensing a beverage formed by multiple components including water, the method comprising:
identifying a dispensing load of the beverage dispenser;
based upon the identified dispensing load, selecting a number of condensing units to be used for chilling incoming water to the beverage dispenser, wherein the number corresponds to the dispensing load;
mounting the condensing units on a common frame;
interconnecting each of the condensing units with a heat exchanger such that (i) coolant exiting the condensing units in parallel is combined and follows a common flow path through the heat exchanger and (ii) coolant exiting the heat exchanger is as single flow is split into parallel paths to feed the condensing units;
connecting a potable water supply for the beverage dispenser to feed from the heat exchanger having been cooled by the heat exchanger;
connecting a cooled water outlet of the heat exchanger to a water supply input of the beverage dispenser such that cooled water from the cooled water outlet is used by the beverage dispenser as a component of the beverage dispensed by the nozzle.

2. The method of claim 1 wherein the dispensing load is determined at least in part as a function of volume of beverage dispensed over time.

3. The method of claim 2 wherein the dispensing load is determined at least in part as a function of volume of ice dispensed over time.

4. The method of claim 3 wherein the dispensing load is determined at least in part as a function of environmental conditions of an installation location of the beverage dispenser.

5. The method of claim 3 wherein the dispensing load is determined at least in part as a function of the ambient environment of the condensing units.

6. The method of claim 1 wherein the frame is sized to receive and hold at least three condensing units.

7. The method of claim 1 wherein the identified dispensing load is an anticipated dispensing load of an installation location of the beverage dispenser.

8. The method of claim 1 wherein the identified dispensing load is determined as a function of monitoring usage of the beverage dispenser at an installation location of the beverage dispenser.

9. The method of claim 1 wherein the number of condensing units is one or more.

10. The method of claim 1 wherein the number of condensing units is two or more.

11. The method of claim 1 wherein, as at least one of a cooling load or the dispensing load of the cold beverage dispensing system changes over time, changing the number of condensing units to be used for chilling the incoming water to the beverage dispenser.

12. The method of claim 1 wherein the condensing units are controlled such that the condensing units are all commonly ON or commonly OFF according to one or more of (i) a monitored temperature of the heat exchanger, (ii) a monitored temperature of glycol exiting the heat exchanger, or (iii) the potable water supplied to at least one of the beverage dispenser or the ice maker.

13. The method of claim 1 wherein each of the condensing units is individually controlled according to one or more of (i) monitored temperature of glycol entering the condensing unit, (ii) monitored temperature of a refrigerant to coolant heat exchanger within the condensing unit, or (iii) the potable water supplied to at least one of the beverage dispenser or the ice maker.

14. The method of claim 1 wherein each condensing unit includes a respective compressor and coolant to refrigerant heat exchanger.

15. The method of claim 1 wherein a common pump feeds coolant to each of the condensing units.

16. The method of claim 1 wherein the ice maker includes an ice bin and a cold plate in the ice bin, and the method involves flowing the cooled water through the cold plate before delivery to the nozzle.

17. The method of claim 1 wherein cooled water from the cooled water outlet is also delivered to the ice maker for making ice.

18. The method of claim 1 wherein the coolant includes propane.

19. A method of operating a cold beverage dispensing system that includes a beverage dispenser having an ice maker and at least one nozzle for dispensing a beverage formed by multiple components including water, the method comprising:
mounting at least one condensing unit on a frame;
interconnecting the condensing unit with a heat exchanger such that coolant exiting the at least one condensing unit follows a flow path through the heat exchanger and back to the at least one condensing unit;
connecting a potable water supply for the beverage dispenser to feed from the heat exchanger having been cooled by the heat exchanger;
connecting a cooled water outlet of the heat exchanger to a water supply input of the beverage dispenser such that cooled water from the cooled water outlet is used by the beverage dispenser for (i) for making ice and/or (ii) as a component of the beverage dispensed by the nozzle.

20. The method of claim 19 wherein water exits the heat exchanger at a temperature of between about 35° F. and about 55° F.

21. A system for dispensing cold beverages, comprising:
a beverage dispenser having an ice maker and at least one nozzle for dispensing a beverage formed by multiple components including water;
multiple condensing units mounted on a common frame;
a heat exchanger;
the condensing units interconnected with the heat exchanger such that (i) coolant exiting the condensing units in parallel is combined and follows a common flow path through the heat exchanger and (ii) coolant exiting the heat exchanger as single flow is split into parallel paths to feed the condensing units;
a water supply connected to feed into the heat exchanger for being cooled, a cooled water outlet of the heat exchanger connected to deliver cooled water to the beverage dispenser such that the cooled water is used by the beverage dispenser as a component of the beverage dispensed by the nozzle.

22. The system of claim 21 wherein the frame is sized to receive and hold at least three condensing units.

23. The system of claim 21, further comprising:
a controller connected and configured to control operation of the condensing units such that the condensing units are all commonly ON or commonly OFF according to one or more of (i) monitored temperature of the heat exchanger, (ii) monitored temperature of coolant exiting the heat exchanger, or (iii) cooled potable water exiting the heat exchanger.

24. The system of claim 21, further comprising:
each condensing unit including a respective controller configured to control operation of the condensing unit according to one or more of (i) monitored temperature of glycol entering the condensing unit or (ii) monitored temperature of a refrigerant to coolant heat exchanger within the condensing unit.

25. The system of claim 24 wherein an ON temperature set point of a first one of the condensing units is different than an ON temperature set point of a second one of the condensing units.

26. The system of claim 21 wherein the ice maker includes an ice bin and a cold plate in the ice bin, and a path followed by the cooled water passes through the cold plate before reaching the nozzle.

27. The system of claim 21 wherein the ice maker of the beverage dispenser includes a cooling system that is separate from the condensing units that feed coolant to the heat exchanger to cool incoming water.
